(19) United States
(12) Patent Application Publication
(10) Pub. No.: US 2012/0241085 A1
(43) Pub. Date: Sep. 27, 2012

(54) Creation of very thin dielectrics for high permittivity and very low leakage capacitors and energy storing devices and methods for forming the same

(76) Inventor: David Carver, Colorado Springs, CO (US)

(21) Appl. No.: 13/426,440

(22) Filed: Mar. 21, 2012

Related U.S. Application Data
(60) Provisional application No. 61/466,058, filed on Mar. 22, 2011.

(51) Int. Cl. B32B 37/12; B05D 5/12; C08K 5/17; C08K 5/3492; C08K 5/09; C08K 5/092; C08K 3/32; H01G 13/00; C08K 5/42

(52) U.S. Cl. 156/275.5; 156/326; 156/336; 427/79; 427/541; 524/238; 524/157; 524/394; 524/381; 524/239; 524/417; 524/100; 524/101; 524/195; 524/392

(57) ABSTRACT

Methods are disclosed for creating extremely high permittivity dielectric materials for use in capacitors and energy storage devices. High permittivity materials suspended in an organic non-conductive media matrix with enhanced properties and methods for making the same are disclosed. A general method for the formation of thin films of some particular dielectric material is disclosed, wherein the use of organic polymers, shellac, silicone oil, and/or zein formulations are utilized to produce thin film low conductivity dielectric coatings. Additionally, methods whereby the formation of certain transition metal salts as salt or oxide matrices at low temperatures utilizing mild reducing agents are disclosed. Further, a method for the enhancement of dielectric permittivity formation in the dielectric material of the capacitor is taught.

This application claims the benefit of and priority to U.S. Provisional Application Ser. No. 61/466,058, filed Mar. 22, 2011, the entire contents of which are incorporated by reference herein in its entirety.

### TECHNICAL FIELD

This disclosure relates generally to capacitors and energy storage devices. More specifically, this disclosure relates formulations for creating high permittivity low leakage capacitors and energy storing devices, and improved methods for forming the same.

### BACKGROUND OF THE INVENTION

To prevent confusion concerning term used in this disclosure the following definitions are provided as explanatory.

Dielectric breakdown voltage is also known as the dielectric strength of a material. The term “permittivity” is now used (mostly) to describe the ability of a material to charge polarize and store energy. Dielectric breakdown voltage is a term sometimes used to indicate the dielectric strength of the material.

The relative permittivity of a material is simply the measurement of its static dielectric constant divided by the dielectric constant of vacuum as shown in the following:

er=es/eO

where

er=relative permittivity

es=measured permittivity

eO=electrical permittivity of vacuum (8.8542 E-12 F/m)

Thus, when the term good dielectric is used, this is meant (usually) to mean a material that displays good electrical insulation characteristics such as a high breakdown voltage and a low conductivity. A material that has a good “dielectric constant” for a capacitor means it has a good “permittivity” (high value) and increases the capacitance of a given size capacitor when placed between the electrodes by a “good” (or high) amount.

A capacitor is formed when two conducting plates are separated by a non-conducting media, called the dielectric. The value of the capacitance depends on the size of the plates, the distance between the plates and the properties of the dielectric. The relationship is:

C=e0er*A/d

where,

eO=electrical permittivity of vacuum (8.8542 E-12 F/m)

er=relative electrical permittivity of the material

A=surface of one plate (both the same size)

d=distances between two plates

Whereas the electrical permittivity of a vacuum is a physical constant, the relative electrical permittivity depends on the material.

TABLE 1
Typical Relative Electrical Permittivity of Materials

| Material | eᵣ |
|---|---|
| Vacuum | 1 |
| Water | 80.1 (20. degree. C.) |
| Organic Coating | 4-8 |

A large difference is noticed between the electrical permittivity of water and that of an organic coating.

It is interesting to note that materials which have large dipole moments and high permittivity are often conductive salts or very polar inorganic acids or bases. In these cases their liquid form is difficult to use and/or toxic or corrosive. This makes their utility difficult and dangerous. Often the inorganic and organic polar salts display undesirable conductivity when they are slightly impure and/or exposed to atmospheric conditions with humidity.

The inorganic salts which display non-conductive behavior and very high permittivity are inorganic salts of the transition metals and other inorganic salts that display high permittivity due to their crystal lattice structures. Use of these materials is difficult due to their crystalline nature. Much effort has been expended to make these types of material more manufacturable through the use of thin coatings and methods of high temperature fusing and sintering.

### SUMMARY OF THE INVENTION

In summary, the techniques described herein provide improvements for creating very thin film dielectric materials with extremely high permittivity which increases the amount of energy able to be stored in a capacitor or energy storage device.

Several high permittivity materials in an organic non-conductive media with enhanced properties and methods for making the same are disclosed.

According to one or more features of the disclosure, a method for the formation of thin films of some particular dielectric material is disclosed, wherein the use of organic polymers, shellac, silicone oil, and/or zein formulations are utilized to produce low conductivity dielectric coatings. Additionally, in accordance with one or more features of the disclosure, a method whereby the formation of certain transition metal salts as salt or oxide matrices is demonstrated at low temperatures utilizing mild reducing agents.

Additionally, in accordance with one or more features of the disclosure, a general method for increasing the permittivity of the dielectric material is disclosed.

### BRIEF DESCRIPTION OF THE DRAWINGS

FIG. 1 is a process flow chart showing the steps used to mix and produce a slurry of dielectric material prior to applying the dielectric material to electrode plates.

FIG. 2 is a process flow chart showing the steps used to apply the slurry to electrode plates and dry or cure the dielectric material.

FIG. 3 is a process flow chart showing an alternate drying or curing process where an electric field is placed across the electrode plates while the dielectric material is being dried or cured.

FIG. 4A is a depiction of a cross section of a high permittivity capacitor with a polymer matrix supporting particles of dielectric material.

FIG. 4B is a depiction of a cross section of a high permittivity capacitor without a polymer matrix supporting particles of dielectric material.

FIG. 4C is a depiction of a cross section of a high permittivity capacitor with a polymer matrix supporting particles of dielectric material and an apparatus to apply an electric field across the electrode plates.

FIG. 4D is an expanded view depiction of a cross section of a high permittivity capacitor with a polymer matrix supporting particles of dielectric material.

FIG. 4E is a depiction of a cross section of a high permittivity capacitor with a polymer matrix supporting particles of dielectric material and an apparatus to apply a magnetic field to the capacitor while it is being cured or dried.

FIG. 4F is a depiction of a cross section of a high permittivity capacitor with a polymer matrix supporting particles of dielectric material and an apparatus to apply a magnetic field across the capacitor while it is being cured or dried and at the same instance, an electric field across the electrode plates.

### DETAILED DESCRIPTION

The present disclosure is directed to several methods of forming high permittivity low leakage capacitors and energy storing devices.

In one or more embodiments, the methods, materials and devices described in the present disclosure reduce the difficulties associated with the manufacture of high permittivity materials, decrease the difficulty of incorporation of these materials into devices, increase the performance of the materials, and show a method whereby the materials performance may be enhanced through the use of external fields used during manufacture.

To determine the work that must be done to charge a capacitor (i.e. the potential energy=E), the work performed is equal to the potential energy stored in the capacitor. The work performed to transfer a given amount of charge into a given capacitance is given by the following formula:

E=W=C*V2/2

In one or more embodiments, it is therefore important that the voltage rating for the capacitor be as high as possible when energy storage is the primary use for the device. In one or more embodiments, besides having a high breakdown voltage, the capacitors herein disclosed also possess an extremely low leakage current. In other words, when the capacitor has been charged to a given voltage, the rate of charge conduction from one electrode to the other should be a relatively small value. When the capacitor is charged for energy storage over some given period of time, the rate of leakage should be an acceptably low enough value that would vary depending on the use of the storage device (how long is it stored) and the “value” of the energy thus stored (how easy is it to recharge and the cost of the charge). An acceptable value for leakage would typically vary greatly from application to application. In all embodiments, leakage is something that is generally avoided and minimized.

In one or more embodiments, the highest value of relative permittivity and the highest voltage rating possible for a given level of leakage provides the best capacitor when evaluated for most energy storage applications. It should also be noted that the ability of the capacitor to discharge and charge at a reasonable rate is also an important factor. For most electronic applications, the ability of a capacitor to act as an ideal capacitor is an important parameter, especially when working at frequencies in the MHz range and above. The capacitor should also have the ability to fully discharge the charge that has been placed into its electrodes. All capacitive devices suffer from “irreversible dielectric absorption”, but in the field of energy, discharging a capacitor to a level that is determined by its application will place a limit on how much of this effect is acceptable. The term dissipation factor is generally used to describe these losses, but in the field of energy storage the term “round trip efficiency” is also used. In our case both terms will be used for these general purpose energy storage devices.

The general class of energy storage devices described herein is referred to as HED (High Energy Density) capacitors. These capacitors are electrostatic capacitors that should be distinguished from EDLC (Electrical Double Layer Capacitor) type of capacitors commonly referred to as supercapacitors or ultracapacitors. The capacitors described in this patent are referred to as Polyastics™ type of capacitors. This name will refer to the method by which they are made as well as the chemical make-up of the materials used in their construction.

In one or more embodiments, substantial improvements in the voltage rating, leakage current and dielectric permittivity of an energy storage capacitor are provided. The scope of the improvements are generally described herein as they relate to the field of energy storage, but the methods and devices described herein can further be applied to other general applications wherein such improvements can be utilized to make devices that displays enhanced characteristics, including better frequency response and reduced dielectric absorption.

In one or more embodiments, a high permittivity low leakage capacitor and energy storage device is described having the following improved characteristics:

1) High voltage rating (High break-down voltage),
2) High relative permittivity,
3) Low leakage current at maximum voltage charge,
4) Small size and weight,
5) Safe use due to low toxicity and other hazards,
6) Easy and better manufacturing procedures,
7) Environmentally friendly manufacturing,
8) High rate of discharge and charge, and
9) Ability to fully discharge.

It should be noted that previously known high permittivity materials have been subject to aging and brittleness, thereby providing substantial difficulty in forming such materials into the required shapes for their various uses. Further, since several of these previously known high permittivity materials are toxic, conventional machining and forming steps are deemed undesirable in a normal work environment. Due to their mechanical instability, the previously known high permittivity materials were also prone to electrical fatigue and mechanical fatigue when subjected to repeated electrical activations. Also, previously known high permittivity materials needed to be protected from the environmental changes, such as humidity changes, that can lead to micro fractures in the material and subsequent electrical failures. There was also a need to form previously known high permittivity materials at high temperatures. Due to their somewhat complex crystalline structures and need to be formed at high temperature, it has traditionally been difficult to make high permittivity materials into thin films. Often the crystal structures were poorly formed and the thin films showed reduced permittivity as thin films versus their bulk property. This is due to the fact that the permittivity of the known materials falls off sharply as the density of the electric field increases.

To alleviate these mechanical and electrical problems, in one or more embodiments, a permittivity material is provided that is mechanically ground and dispersed into an organic polymer for low temperature processing (i.e., temperature processing below approximately 500 degrees Celsius). Alternatively, a material is described wherein the dielectric is formed as a mixture of either homogeneous nature or heterogeneous nature.

In different embodiments described herein, a variety of materials are described as being mixed and suspended in various polymers that possess the desired enhanced characteristics. In one or more embodiments, shellac and zein are found to offer enhanced properties for this application. In the case of both of these materials, the water and alcohol solubility of the polymer precursors provide desirable properties. Alternatively, polymers comprised of polyurethane, acrylic acid, methacrylic acid, methacrylic amides, polyvinylsulfonic acid, cyanoacrylates, polyvinylalcohols, polylactic acid, polyethylene terephthalates (PET), parylenes, silicones, or polyvinylsilanes have been demonstrated to provide enhanced dielectric properties when used with dielectric materials that need to be suspended in a polymer matrix. Although this list is not an exhaustive list of polymers that can be used, substitution of the polymer matrix with a variety of different polymers and/or non-electrically conductive materials is possible without modifying the novel substantive nature of the method.

In one or more embodiments, using the mechanically ground dielectrics, the permittivity of a suspension of the dielectric in the organic binder was enhanced by approximately 25% using shellac and zein over their dry particulate forms. Similar results were obtained with other polymers as listed above.

In one or more embodiments, an in situ formation of the dielectric was also performed to produce unique dielectrics possessing unique characteristics. In these embodiments, the addition of NaBH4 in an alcoholic solution of zein was used to produce and enhance the functionality of the mixture. The resulting mixture, when treated with concentrated ammonium hydroxide and then heated, produces greatly enhanced dielectric material with permittivity increases on the order of 250% based on their change in permittivity from their simply being mixed with the organic binders. While even greater optimizations may are anticipated and the viability of the procedure and its substantial utility have been shown by the resulting properties of such a mixture.

In one or more embodiments, the dielectric compounds when suitably ground may alternatively be mixed with silicone oil and a small amount of borax or sodium borohydride. When heated to 150 Celsius, similar results of increases up to 250% as when the organic polymer suspensions were used.

In the above-described embodiments, when the mixtures were placed between two electrodes in a capacitor arrangements with an approximate spacing of 10 microns, the use of either the shellac, zein, or silicone oil polymers or alternatively polyurethane, acrylic acid, methacrylic acid, methacrylic amides, polyvinylsulfonic acid, cyanoacrylates, polyvinylalcohols, polylactic acid, polyethylene terephthalate (PET), parylenes, or polyvinylsilanes resulted in undetectable leakage currents when the voltage between the electrodes was raised to 300V. To the contrary, when dielectric material such as barium titanate was ground and pressed in between the electrodes, it showed unacceptable leakage currents when tested at 300 V.

Due to the advantages of low temperature processing, a variety of organic dielectrics have been formed and tested. Classes of compounds that have been invented include several cesium and rubidium salts of organic acids. Additionally, salts of IB metals have been used in both the +1 oxidation state and the +2 oxidation state. Salts of the IIIA including gallium and indium in presumably the +1 oxidation state have been used.

In particular the salts of the following have been tested.

### a) Cysteine

### b) Taurine,

c) Carballylic acid
d) Citric acid

### e) Glutathione

### f) Citrulline

g) Potassium dihydrogen phosphate
h) Ethylenediaminetetraacetic acid
i) Trithiocyanuric acid
j) Cyanuric acid
k) Tartaric acid
l) Salicylic acid

### m) Arginine

### n) Cystine

o) succinic acid
p) maleic acid

Exceptional performance of the dielectric was obtained in the salt formation of the above acids using cesium and the rubidium ions that are good electrically polarizable ions. These organic salts may be easily formed by the use of the carbonate form of the elements mentioned. The carbonate form provides for a release of carbon dioxide and no undesired counterion contamination of the resulting ionic salt. However, it is clear that other inorganic single atom salts could be used (such as Cu(I) or Cu(II)) to provide similar dielectric properties without substantive change in the following procedures. Salts of these elements IA elements in addition to the silver and copper +1 oxidation states have shown good permittivities when used in a manner as set forth by the embodiments contained herein.

Modification of the resulting salts with thioureas and/or other related chemical species to the thioureas such as biurets, and modifications of the structures of the thioureas or thiobiurets show the dielectric permittivities to be enhanced over formulations that do not contain these species. When these sulfur containing compounds were used in conjunction with the salts mentioned above-described, then the resultant dielectrics in most cases displayed improved permittivities than without the sulfur containing formulations. Sulfur containing compounds used include, but are not limited to, N-allylthiourea, 1-(2-methoxyphenyl)-2-thiourea, trithiocyanuric acid, diphenylthiourea, and taurine. Sulfur compounds in the following list work.

a) Thioureas

b) Thiobiurets

c) Thiouracil

d) Mercaptans

e) Thiophenol

Amino acids and proteins can be used as well. Of particular significance is the use of glutathione, methionine, cysteine, and/or cystine which are sulfur containing amino acids. They have particular significance when used with guanidine to form salts. Also, the arginine amino acid is noted, since it contains both the basic guanidine moiety as well as the carboxylic acid group.

Common carboxylic acids have been used including citric acid, citrulline (an amino acid), succinic acid, and carballylic acid. Of particular note is the performance of the acids when the +1 salts of rubidium and cesium as well as the IB elements in their +1 oxidation states are used. Other ions that could be used in include In (I or II), Ga (I or II), either in conjunction with their less expensive IA and IIA elements or as single counterions.

Common bases other than the single atom salts mentioned previously can be used. Of particular significance is the salt of guanidine. In this molecule we have extended tautomers and electronic distribution in the protonated form. This helps distribute the electronic structure of the resultant salt and increase the polarizability of the species. In those salts increased dielectric permittivities were noted. In general amine bases and especially those in which there is extended conjugation of the charge in the base, provide a good counterbalanced charge carrier for the dielectric. Bases include amines, anilines, pyridines, anilines, and other nitrogen containing bases of this nature. Polymeric forms of nitrogen bases can also be used.

During the curing phase of manufacture where the magnetic or electric field is imposed upon the dielectric material, it was noted that increased electric field results in increased permittivities. At the low electric field potentials, the increase in permittivity was proportionally increased with the increase in the electric field potential. In some salts of inorganic metal ions an increase in the permittivity when placed in a magnetic field was observed. Additionally, it has been found that magnetic fields help in the enhancement of the dielectric's permittivity in purely organic compounds as well.

Utilization of both an electric field and a magnetic field can help reduce the requirements for the strength of either field when used in simultaneously with materials that respond to the magnetic field. When electric field strengths of almost any magnitude were impressed upon the dielectric when it was in a pliable or less viscous state, and increase in the permittivities of the resulting salt was shown. This again is possible due to the low temperature processes we have discovered. Electric field strengths of >100 V/cm were used to provide greater than 100% improvement in the permittivities of several different organic and inorganic dielectrics. Magnetic fields were also used to cause increases in the permittivities. Even relatively small magnetic field (i.e. >1 Gauss) has caused observable increases in the permittivity of polymeric materials and/or crystallization of polymers, small molecule organics, and salts of both inorganic and organic nature. Strong magnetic fields seem to induce greater amounts of permittivity increases than small fields. Permittivities in the range of 7 to >2000 have been observed utilizing the methods taught.

It may be that in the case of a molecule in which there is substantial polarization and/or separation of charge due to zwitterionic structures, the acid and the base may be contained within the molecule itself. In those cases, the ability to have high dielectric polarization may be “complete” within the single molecule itself. In several cases, we have seen good permittivities with amino acids where this exact form is present. In those cases, the selection of the solid matrix is important. This is where the selection of a polymer may come into play. However, in many protein matrices, the ionic forms may be encapsulated which the protein backbone itself. In the case of zein, this is thought to be an example where this has actually happened, produced a high permittivity dielectric.

The following representative embodiments will set forth specific examples of methods of making a high permittivity material in accordance with the present disclosure. It is understood that the disclosure need not be limited to the disclosed embodiments but it is intended to cover various modifications thereof, including combinations of the steps and components of the various examples.

### Procedures:

I. Procedure for Making a Reduced Leakage Current Dielectric for Use in a Capacitor or Energy Storage Device.

In one or more embodiments, 1.5 g of zein is added to 15 mL of ethanol. A small amount of water is added or optionally the solution is filtered or centrifuged to remove any undissolved particulate matter. The resulting clear solution is then treated with 0.5 g to 15 grams of high permittivity inorganic salt such as barium titanate powder that has been previously treated to be made into a nano powder or other fine dispersion material. The resulting slurry is then mixed thoroughly and screened or otherwise spread on the target electrode. Addition of a small amount of DMSO (Dimethylsulfoxide) or DMF (Dimethyl formamide) will facilitate the screening and drying process. The “green sheet” material may then be dried at low temperature or alternatively clamped or otherwise pressed in contact with the other plate electrode. Elevated drying temperatures of not over approximately 60.degree. C. (as excessive temperature can lead to bubble formation and cavitation of the film) are then maintained until all solvents have been removed. Further heating at 150 degrees Celsius can be performed.

II. Procedure for Making a High Permittivity Dielectric Utilizing Low Temperature Methods

In one or more embodiments, 0.75 g of strontium II carbonate is added to a stirred solution of 1.5 g gadolinium III carbonate in 15 mL of DI water. After dissolution of the two compounds takes place, a solution of 200 mg of zein (or other organic polymer) in 2 mL of water with 200 mg of sodium borohydride is added drop-wise to the metal solution with good stirring. The organic polymer material is optional if the dielectric material is to be formed or isolated without binder. A small amount of acetic acid may be added to facilitate the reduction. After 5 minutes 5 mL of concentrated ammonium hydroxide is added. After 5 more minutes, the solution may be filtered and then screened, spread, or spun coated onto the desired electrode material and evaporated and treated as described in Procedure I. Or the solution can be evaporated to isolate the dielectric material as a solid.

III. Procedure for Reducing the Leakage Current in a Dielectric that has a Small Amount of Conductivity

In one or more embodiments, 1.5 g of Zein is dissolved in 15 mL of ethanol. 5 to 50 mL slurry of the desired dielectric material is then treated with the zein solution with good agitation. The slurry may then be spread, screened, or spun coated onto the electrode and treated as described in procedure I to produce a device.

IV. Procedure for Reducing the Leakage Current Utilizing Shellac or Other Polymers and a High Permittivity Material

In one or more embodiments, to a 1.5 g sample of the high permittivity material as produced by a procedure herein wherein the dielectric is isolated as a solid powder or in liquid form is added 1.5 g of commercial grade shellac solution (Zinnser #00301) that has been filtered or centrifuged to remove particulate matter. Additional ethanol can be added as needed to make the material into a workable slurry or solution. The resulting liquefied material can then be spread, screened or spun coated onto the electrode material as noted in procedure I.

V. Procedure for the Use of Silicone Oil and a Dielectric Material as a Capacitor

In one or more embodiments, 1.0 g of silicone oil is added to a finely ground high permittivity dielectric of weight from 0 to 5 g. The mixture is well stirred and a small amount of sodium borohydride or borax salt (0 to 500 mg) is added to the slurry or solution. If the solution or mixture is workable, it can then be spread, screened, or spun, onto an electrode. The sheet can then be heated to approximately 150 degrees Celsius to 300 degrees Celsius for a few minutes to facilitate the increase in viscosity of the silicone oil. The top electrode can then be pressed or otherwise fastened with pressure to the silicone formed electrode and then heat treated for a period of time sufficient to fully stabilize the dielectric material. For example, approximately three hours at 150 to 200 degrees Celsius is sufficient, although less time and different temperatures may be acceptable and are anticipated.

VI. Method of Making High Permittivity Organic Dielectrics:

1) Choose an organic acid. In the cases we have used to date, the more polarized the resultant conjugate base of the acid, the better the resulting dielectric will be in most cases. In several cases, the carboxylic acid salt has been used with good results. However, when the oxygen of the acid was replaced with a sulfur atom, the resultant dielectric had better permittivity. This is not a hard and fast rule; however, since the delocalization of the electronic cloud of the salt can take place by alternative means. The delocalized structures of cyanuric acid show that the addition of sulfur is not always necessary. Additionally, the less odoriferous nature of the non-sulfur (or selenium) containing compounds is also an advantage.

2) Choose a base. As with the acid, the base preferably, but not necessarily, needs to be polarized and have delocalized electrons when in its conjugate acid form. And, as with the acid, the same criteria regarding the selection of atoms should be noted.

3) Choose a polymer matrix. This is an optional step since the selection of the acid and base pair noted above may give a matrix whereby the next selection criteria are fulfilled. In other words the acid and base combination may ultimately produce a dielectric that is solid and stable to an electric field and have dissipation factors that make it a desirable formulation. In those cases the polymer in this step is not necessary. As an alternative to mixing the monomer or oligomeric species together with the high permittivity dielectric, the monomer, oligomer, or polymer may be used singularly or as a singular or multitude of thin layer(s) within the dielectric spacing of the capacitor (energy storage area).

4) If the acid/base mixture is to be used with the polymer, mix the acid and the base either individually or premixed with the polymer, or alternatively mix them separately from the polymer and isolate the resulting salt. The resulting salt can then be suspended with the monomer of the polymer selected or used with an oligomeric form of the polymer. In most situations, the salt (or otherwise bound molecular species, i.e. melamine-cyanuric acid complex) may be soluble in the monomer or oligomer with or without solvents, or it may be a slurry or heterogeneous mixture. It is possible to suspend solid forms of the ionic species (or polarizable species) in the matrix as is well known to those in the industry. A homogeneous or heterogeneous mixture is referred to herein as the “slurry”.

5) Take the resulting mixture, either homogeneous, or otherwise, using methods well documented and known to those in the industry, apply the dielectric to one or both of a pair of electrodes. Before the polymer or the dielectric itself undergoes solidification either by cooling, polymerization, or other process whereby the viscosity or the solidification of the dielectric becomes large enough such that the dielectric is stable enough for the intended application, an electric field is applied to the dielectric. Alternatively, or in addition, a magnetic field can be applied to the dielectric when the species being solidified is paramagnetic or ferromagnetic in nature or has paramagnetic or ferromagnetic intermediate states that are influenced by the magnetic field. It may be that the resultant dielectric never becomes solid and remains in a liquid or viscous state, yet retains the increased dielectric permittivity.

6) While under the field(s), the solidification process or reorientation processes are allowed to be completed. The field(s) (either electrical, magnetic, or both) may now be removed. The dielectric may now be used between the electrode layers or removed and subsequently used in other applications.

### Process and Methods

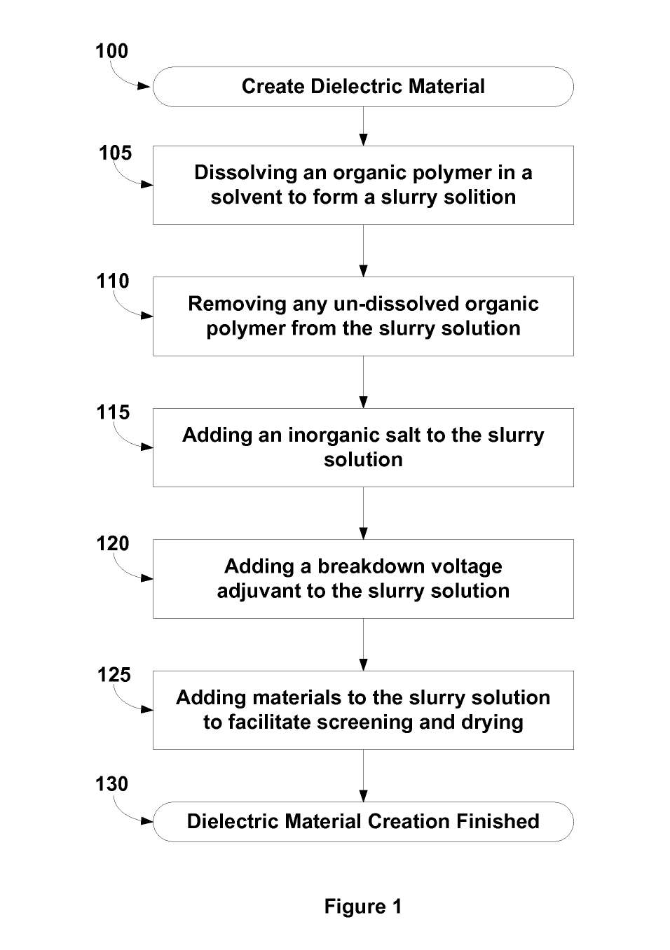

FIG. 1 is an exemplary flow chart illustrating a method for making a high permittivity dielectric material, according to an embodiment of the present disclosure. The method, create dielectric material 100, begins by dissolving an organic polymer in a solvent to form a slurry solution (105). The solvent may be shellac, silicone oil, other polymers, water, ethanol, and/or zein. Other suitable solvents are also anticipated. In one embodiment, removing any undissolved organic polymer from the slurry solution (110), is accomplished for example, by using a filter or centrifuge. Other means of removing undissolved organic polymer from the slurry solution are anticipated. Next, adding an inorganic salt to the slurry solution (115) is executed. The inorganic salt may be a transition metal salt, such as a Gd, Sr, Sn, and/or Fe salt followed by adding a breakdown voltage adjuvant to the slurry solution (120). The breakdown voltage adjuvant may include one or more of Y, Ni, Sm, Sc, Tb, Yb, La, Te, Ti, Zr, Ge, Mg, Pb, Hf, Cu, Ta, Nb, and/or Bi. Discovery and use of other suitable adjuvants is anticipated. The creation process for the slurry containing the dielectric material is then completed by adding materials to the slurry solution to facilitate screening and drying 125. This is accomplished by the addition of a small amount of dimethyl formamide and a Dimethylsulfoxide to the slurry solution (125).

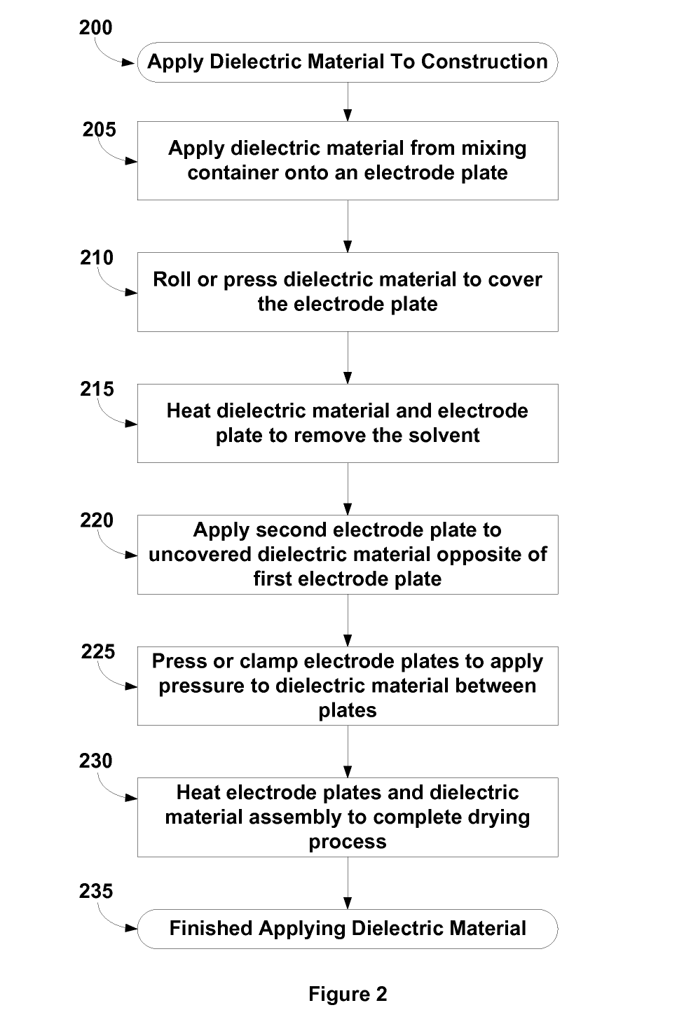

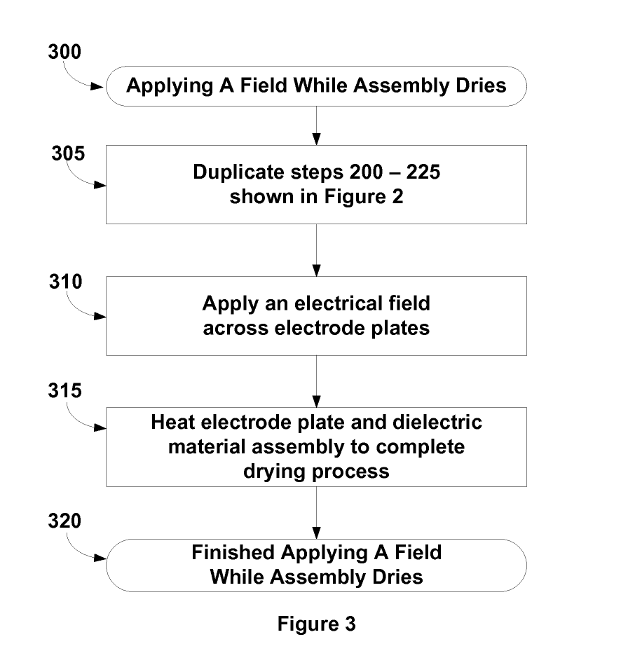

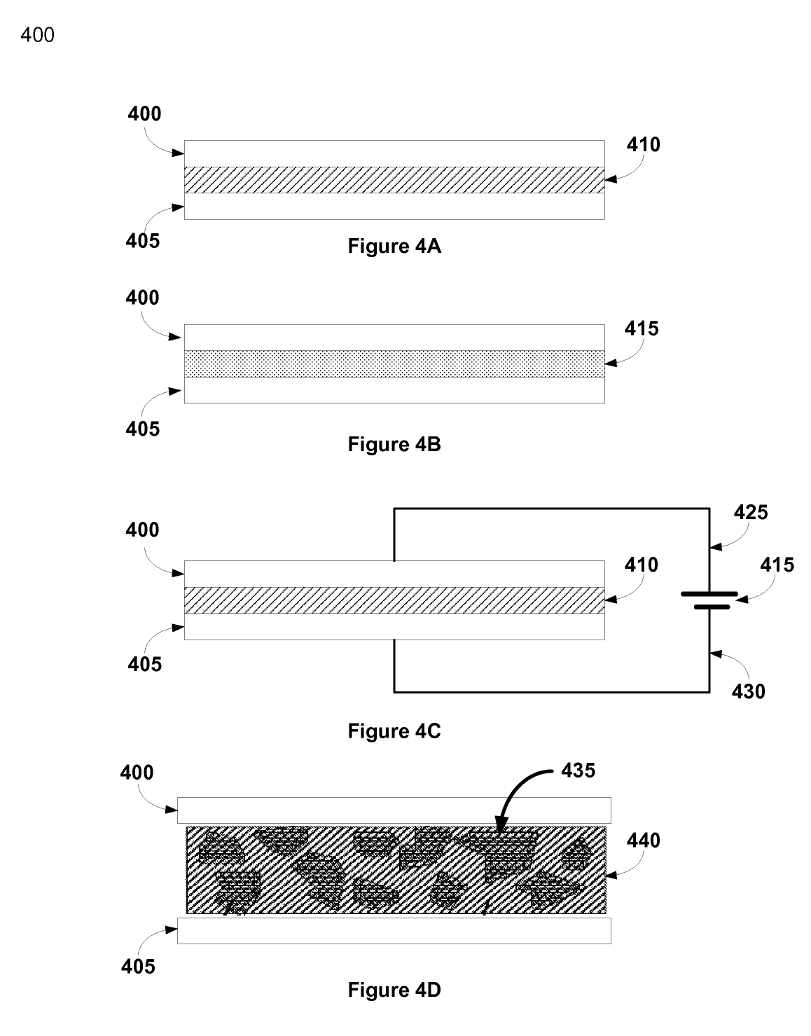

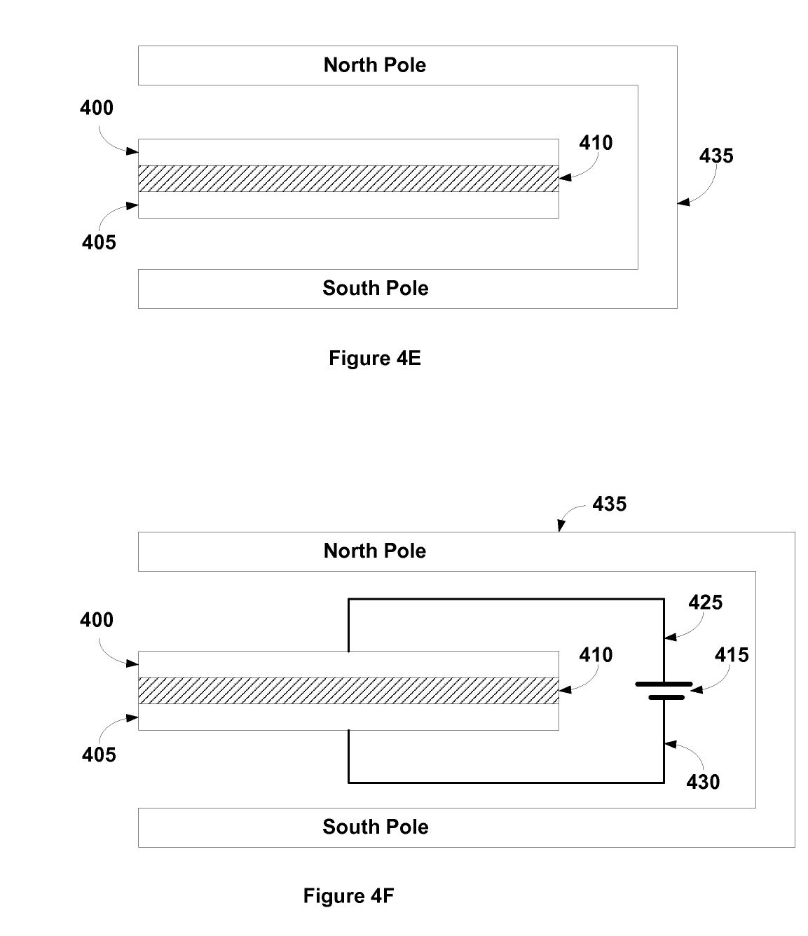

FIG. 2 is an exemplary flow chart illustrating the continuing method for making a high permittivity dielectric material according to the present disclosure. FIG. 2 illustrates the next sequence of the method whereby the resulting slurry is applied to the assembly of electrode plates. Apply dielectric material to construction 200 is the beginning of the assembly process. Apply dielectric material from mixing container onto an electrode plate 205 results in an application of the slurry onto an electrode plate or one half of the capacitor. In a manufacturing environment this step may be accomplished by the slurry being coated onto a stationary or continuous moving strip of an electrode. In a lab environment or one-of manufacturing environment the slurry may be poured onto a statically positioned electrode plate through any number of means such as but not limited to pressure ejected from a container or poured form the mixing container. Other methodologies for moving the slurry from the mixing container to the electrode plate are anticipated. The next process step, roll or press dielectric material to cover the electrode plate 210 is performed to ensure an even thin coating of the slurry onto the electrode plate. Multiple means for performing this step are anticipated including but limited to the use of a spreading blade, roller, or other means. Gas phase deposition of the slurry can be accomplished through atomization of the slurry or chemical vapor deposition as known to those versed in the art. Process step 215 heat dielectric material and electrode plate to remove the solvent is performed to evaporate the solvent in the slurry. Process step 220 apply second electrode plate to uncovered dielectric material opposite of first electrode plate results in the basic high permittivity capacitor which is then ready to be completed. Process step 225 press or clamp electrode plates to apply pressure to dielectric material between plates ensures that any air or gas is forced out of the slurry mixture and the top and bottom electrodes (400 and 405 FIGS. 4A, 4B, 4C and 4D) are in complete contact with the slurry mixture containing the dielectric material. The resulting assembly as shown in FIGS. 4A through 4D is processed by step 230 heat electrode plates and dielectric material assembly to complete drying process. The slurry solution can be heated (depending on the deposition method) to a temperature of about 150 degrees Celsius to about 300 degrees Celsius to remove or evaporate the solvent. Other temperature ranges are anticipated dependent on the solvent used in the slurry. At this point, the process is complete at step 235 finished applying dielectric materials.

FIG. 3 is an exemplary flow chart illustrating an additional embodiment for making a high permittivity dielectric material according to the present disclosure. It has been discovered and is hereby disclosed that when the dielectric compounds are allowed to “set, condense, or polymerize” in their matrix while under the potential of an electric field, or when the electrode plates were in contact with the dielectric slurry material, the permittivities of the resulting capacitors resulted in increased permittivities relative to the same materials not subjected to the electric or magnetic fields. Increases in permittivity of 100% or more have been obtained. The process shown and exemplified in FIG. 3 begins with applying a field while assembly dries 300. Process step 305 duplicate steps 200-225 have shown in FIG. 2 replicates the process of applying dielectric material to the electrode plates of a capacitor under construction. After the dielectric slurry mixture 410 has been placed between the electrode plates 400 and 405 and the electrode plates have been pressed or clamped step 310 apply an electric field across electrode plates is executed. This application of the electric field is shown in FIG. 4C. Note that FIG. 4C is a representation of a capacitor of the disclosed embodiments. The electrode plates of the said capacitor are shown as 400 and 405 with the dielectric material show as 410. These 3 components (400, 405, and 410) make up the disclosed capacitor. An electric field is applied to the said capacitor through connection of an electrical source shown schematically as battery 420. Battery 420 is connected to capacitor electrode plate 400 through connection wire 425 and connection wire 430 to capacitor plate 405. Connection wires 425 and 430 may also be spring contacts and other means of connection from the electrical source to the capacitor plates are also anticipated.

Additionally and alternatively as a substitute the processes noted above, described as liquid transfer processes, can also be executed as vapor phase transfers known to those skilled in manufacturing processes that require film production.

As can be seen from the foregoing description, the present method avoids the high temperature methods associated with prior high permittivity materials by the use of organic substrates to suspend, insulate, and coat the high dielectric materials. High process temperatures are also avoided by the present methods. In addition, a new method for making high permittivity materials is disclosed and when used in conjunction with the high breakdown voltage materials (such as shellac, zein, urethanes, epoxies, acrylics, vinyl polymers, polypropylene, PET, silicones, styrene, parylenes, TFE, and other fluorinated compounds), a process for making a high dielectric capacitor with a high breakdown voltage character is made possible.

Due to the nature of the process, the procedure is rugged in terms of control of leakage current. The coating material is a general material that seems to coat or insulate any material, including contamination materials and it will thereby make manufacture of the device easier and with better yields. Since it is difficult to make most good high permittivity dielectrics pure enough to display low conductivity (and thus producing high leakage currents), the use of organic binders in a matrix of high permittivity material is desirable because the contact of a conductive contamination or a defective crystal that may have conductivity is prevented by the coating of organic substrate.

### Capacitor Cross Sectional Views

FIG. 4A is a cross sectional view of a capacitor of the current embodiments. In this view and the views of FIGS. 4B, 4C, and 4D the component numbers 400 and 405 refer to the 2 electrode plates of the said capacitors. In FIGS. 4A and 4C component number 410 is showing the dielectric particles suspended in a polymer suspension of the current embodiments.

FIG. 4B differs in that number 415 is showing a representation of dielectric particles not suspended in a polymer suspension. This type of construction results in a capacitor with a dielectric that exhibits high and unacceptable leakage currents.

FIG. 4D is a cross-sectional view of a high permittivity low leakage capacitor, according to an embodiment of the present disclosure. As illustrated, the capacitor electrode 400 and its opposite polarity electrode 405 are spaced apart approximately equally. In the intervening space are heterogeneous dielectric materials 430 and 435 are shown. In one embodiment, a dielectric material 440 may be formed from existing materials such as barium titanate or other such known high dielectrics 435, with an insulation material 430 such as parylene, zein, shellac, cross-linked silicones, or other such materials, to fill the intervening spaces between the high dielectric materials 430. Due to the improvements of this invention, a low temperature process using the insulation dielectric 430 can incorporate relatively low temperature stability and melting materials.

FIG. 4 E is a depiction of a high permittivity dielectric in a capacitor that has a magnetic field applied across the capacitor while the dielectric material is being cured or dried which will increase the permittivity of the dielectric material. In this figure, the capacitor assembly is composed of substrates or plates 400 and 405 which contain the dielectric material 410 between them. In this embodiment, a magnet 435 is placed such that the capacitor assembly resides between the north and south poles of magnet 435.

FIG. 4 F is a depiction of a high permittivity dielectric in a capacitor that has a magnetic field applied across the capacitor at the same time that an electric field is being applied across the electrodes while the dielectric material is being cured or dried which will increase the permittivity of the dielectric material. In this figure, the capacitor assembly is composed of substrates or plates 400 and 405 which contain the dielectric material 410 between them. In this embodiment, a magnet 435 is placed such that the capacitor assembly resides between the north and south poles of magnet 435 and at the same time voltage and current source 415 is connected through conductors 425 and 430 to capacitor electrodes 400 and 405 thus applying an electric field across the capacitor assembly.

The methods described herein provide a unique approach for making high permittivity capacitors without having to resort to standard high temperature manufacturing methods that almost no organic compound can withstand. This new approach vastly expands the materials by which these capacitors can be made, and increases the performance of the capacitors due to the reduced leakage currents that many organic polymers can display.

In one or more embodiments, Gd, Sr, Sn and Fe may be utilized as high permittivity dielectrics. In one or more embodiments, shellac, zein, and silicon oil may be used as high voltage breakdown adjuvants. Additional high breakdown adjuvants may be utilized, such as but not limited to phenolic polymers, polyesters, vinyl polymers, polyolefins, polyanhydrides, fluoropolymers, polycarbamates, inorganic polymers, and biopolymers. Examples include, but are not limited to, phenol formaldehyde resin (PF), polyethyleneterphalate (PET), polyacrylic acid and esters (PAA), polyethylene (PE), polypropylene (PP), polymaleic anhydride, polytetrafluoroethylenes and polyvinylidene fluoride (TFE, PVDF), polyvinylidene chloride, polyurethanes, polysilicones, and proteins. In other embodiments, other dielectrics and some breakdown voltage enhancers (adjuvants) may be utilized, such as but not limited to compounds containing Y, Ni, Sm, Sc, Tb, Yb, La, Te, Ti, Zr, Ge, Mg, Pb, Hf, Cu, Ta, Nb, Bi.

In one or more embodiments, organic carboxylic acids are used to form inorganic salts of various single atom ions. These single atom ions include, but are not limited to, IA, and IB elements of the periodic table. Additionally, IIA and IIB elements can be used. These salts when processed by the methods shown below result in greatly enhanced dielectrics.

In one or more embodiments, it was found that the sulfur analog of carboxylic acids and sulfur containing acids were desirable in their salt form utilizing the elements from the IA or IB series of the periodic table. Additionally, thioureas, thiobiurets, and their substituted analogs were found to enhance the dielectric properties.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other devices, other than capacitors, can be made using these techniques.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for improving the process for creating easily spreadable thin coatings of high permittivity dielectric material onto a first substrate at atmospheric pressures, low or ambient temperatures, and ambient humidity without increasing potential leakage currents of said high permittivity dielectric comprising:
a. creating a wetting agent solution by adding an amount of an organic polymer such as, but not limited to, parylene, shellac or zein to a solvent suspension such as, but not limited to, ethanol and mixing said solution;
b. processing said wetting agent solution to remove any particulate matter not dissolved into said solvent suspension;
c. combining said wetting agent solution with said high permittivity dielectric material;
d. mixing said wetting agent solution such that a smooth slurry is created;
e. spreading said slurry in a thin and even coating onto said first substrate;
f. Said slurry may then be dried at low temperature or alternatively clamped or otherwise pressed in contact with at least a second substrate in contact with said slurry and residing opposite to said first substrate.

2. A method for improving the process of creating easily spreadable thin coatings of high permittivity dielectric material onto a first substrate at atmospheric pressures, low or ambient temperatures, and ambient humidity without increasing potential leakage currents of the said high permittivity dielectric comprising:
a. creating a wetting agent consisting of an organic compound such as shellac or zein combined in a solvent suspension such as, but not limited to, ethanol where all of the materials including said solvent, zein or shellac, and said high permittivity dielectric material are combined at the same time;
b. processing said wetting agent solution to remove any particulate matter not dissolved into said solvent suspension;
c. mixing said wetting agent solution such that a smooth slurry is created;
d. spreading of said slurry in a thin and even coating onto the said first substrate;
e. Said slurry may then be dried at low temperature or alternatively clamped or otherwise pressed in contact with at least a second substrate in contact with said slurry and residing opposite to said first substrate.

3. A method for improving the process of spreading of thin coatings of high permittivity dielectric material onto a first substrate at atmospheric pressures, low or ambient temperatures, and ambient humidity without increasing potential leakage currents of said high permittivity dielectric comprising:
a. creating a wetting agent consisting of an organic compound such as parylene, shellac or zein in a solvent suspension such as but not limited to ethanol;
b. processing said wetting agent solution to remove any particulate matter not dissolved into said solvent suspension;
c. combining said wetting agent solution with the said high permittivity dielectric material;
d. adding a drying agent to said wetting agent solution for facilitating drying of said wetting agent said drying agent consisting of, but not limited to, dimethylsulfoxide or dimethyl formamide;
e. mixing said wetting agent solution such that a smooth slurry is created;
f. spreading of said slurry in a thin and even coating onto the said first substrate;
g. Said slurry may then be dried at low temperature or alternatively clamped or otherwise pressed in contact with at least a second substrate in contact with said slurry and residing opposite to said first substrate.

4. A method for improving the permittivity of a dielectric material placed between a first substrate and a second substrate by application of an electric field during a curing or drying process comprising:
a. creating a first solution consisting of a polymer such as, but not limited to, parylene, shellac, zein or silicon oil, into which an amount of a high permittivity dielectric is mixed thereby forming a slurry;
b. placement of said slurry into said first substrate as an even coating;
c. placement of said second substrate onto said slurry opposite to said first substrate;
d. application of an electric field by connection of a current source across said first substrate and said second substrate;
e. Said slurry may then be cured or dried for a first period of time sufficient to cure or dry said slurry.

5. The method of claim 4 whereby the strength of said electric field is greater than 100 V/cm during the curing process.

6. A method for improving the permittivity of a dielectric material placed between a first substrate and a second substrate by application of a magnetic field during a curing or drying process comprising:
a. creating a first solution consisting of a polymer such as, but not limited to, parylene, shellac, zein, or silicon oil, into which an amount of a high permittivity dielectric is mixed thereby forming a slurry;
b. placement of said slurry into said first substrate as an even coating;
c. placement of said second substrate onto said slurry opposite to said first substrate thereby forming a capacitor assembly;
d. placement of said assembly between the magnetic poles of a magnetic source such that the magnetic field between the north pole of said magnetic source and the south pole of said magnetic source is perpendicular to the outer surfaces of said first and second substrates of said capacitor assembly;
e. Said slurry may then be cured or dried for a first period of time sufficient to cure or dry said slurry.

7. The method of claim 6 step d, whereby said capacitor assembly is placed between the magnetic poles of a magnetic source such that magnetic field between the north pole of said magnetic source and the south pole of said magnetic source is parallel to the outer surfaces of said first and second substrates of said capacitor assembly prior to said assembly being cured or dried for a first period of time sufficient to cure or dry said slurry.

8. A method of any one of claim 6 or 7 whereby the strength of said magnetic field is greater than 1 Gauss during the curing process.

9. A method for improving the permittivity of a dielectric material placed between a first substrate and a second substrate by application of a magnetic field and an electric field during a curing or drying process comprising:
a. creating a first solution consisting of a polymer such as, but not limited to, parylene, shellac, zein or silicon oil, into which an amount of a high permittivity dielectric is mixed thereby forming a slurry;
b. placement of said slurry into said first substrate as an even coating;
c. placement of said second substrate onto said slurry opposite to said first substrate thereby forming a capacitor assembly;
d. application of an electric field by connection of a current source across said first substrate and said second substrate and placement of said assembly between the magnetic poles of a magnetic source such that the magnetic field between the north pole of said magnetic source and the south pole of said magnetic source is perpendicular to the outer surfaces of said first and second substrates of said capacitor assembly;
e. Said slurry may then be cured or dried for a first period of time sufficient to cure or dry said slurry.

10. Any of the methods of claim 9 whereby the strength of said electric field is greater than 100 V/cm and the strength of said magnetic field is greater than 1 Gauss during the curing process while the polymer increases in viscosity.

11. The method of claim 9 step d, whereby said capacitor assembly is placed between the magnetic poles of a magnetic source such that magnetic field between the north pole of said magnetic source and the south pole of said magnetic source is parallel to the outer surfaces of said first and second substrates of said capacitor assembly prior to said assembly being cured or dried for a first period of time sufficient to cure or dry said slurry.

12. The method of claim 9 wherein a dielectric is suspended in a polymer base and subjected to a magnetic field greater than 1 Gauss and/or an electric field of greater than 100 V/cm during a curing process wherein the dielectric increases in viscosity either through increased glass transition temperatures, cooling, or by crystallization.

13. A method for producing a strong flexible polymer matrix supporting a dielectric material through cross linking of an agent introduced into said polymer matrix comprising:
a. creating a first solution consisting of a polymer such as, but not limited to, shellac, zein or silicon oil, into which an agent capable of cross linking the molecules of said polymer, said agent being, but not limited to, divinylsilane, cyanoacrylate, or some epoxy formulation, and thoroughly mixed;
b. an amount of said dielectric material is then added to said first solution;
c. continued mixing of said first solution such that a smooth slurry is created;
d. spreading of said slurry in a thin and even coating onto a substrate;
e. placement of a second substrate onto said slurry and opposite to said first substrate;
f. Allowing said slurry to cure or dry for a first period of time.

14. A method for producing a high temperature easily worked dielectric capable of tolerating solder reflow temperatures through the use of silicone oil as the supporting polymer matrix with the addition of Fe+2 or Fe+3 comprising:
a. creating a first solution consisting of a polymer such as, but not limited to, silicon oil, into which an agent consisting of, but not limited to, Ferrous Iron (Fe2+) or Ferric (Fe+3), is added and thoroughly mixed;
b. an amount of said dielectric material is then added to said first solution;
c. continued mixing of said first solution such that a smooth slurry is created;
d. spreading of said slurry in a thin and even coating onto a substrate;
e. placement of a second substrate onto said slurry and opposite to said first substrate;
f. said assembly of said first substrate, said slurry, and said second substrate is then cured or dried for a first period of time at a low temperature.

15. A method for increasing the permittivity of a dielectric material by adding sodium borohydride as a reducing agent in a solvent suspension containing the dielectric when treated with a concentrated solution of ammonium hydroxide and heated comprising:
a. creating a first solution consisting of an organic compound such as shellac or zein in a solvent suspension such as but not limited to ethanol;
b. processing said solution to remove any particulate matter not dissolved into said solvent suspension;
c. mixing into said first solution an amount of said dielectric material;
d. an amount of said sodium borohydride is added to said first solution as a reducing agent and mixing is continued until said first solution is reduced resulting in a slurry;
e. said slurry is then heated at a first temperature for a first period of time;
f. said slurry is then spread in a thin and even coating onto a first substrate;
g. placement of a second substrate is them made onto said slurry and opposite to said first substrate;
h. said assembly of said first substrate, said slurry, and said second substrate is then cured or dried for a second period of time at a second temperature.

16. A method for producing a high permittivity dielectric material in a low or ambient temperature environment comprising:
a. creating a first solution consisting of de-ionized water into which an amount of strontium II carbonate and an amount of gadolinium III carbonate are mixed;
b. creating a second solution consisting of an amount of water into which an amount of an organic polymer such as, but not limited to, zein or shellac and an amount of sodium borohydride;
c. creating a third solution by combining said first solution and said second solution with a small amount of acetic acid to facilitate a reduction of said third solution while said third solution is continually mixed;
d. after a first period of time an amount of concentrated ammonium hydroxide is added to said third solution with mixing continued;
e. after a second period of time of mixing, said third solution is a well-mixed slurry that is then spread in a thin and even coating onto a first substrate material;
f. said slurry may then be dried at low temperature or at an elevated temperature sufficient to dry said slurry but not elevated to a point where bubbles for in said slurry or said substrate suffers cavitation;
g. alternatively, said slurry and said first substrate may be clamped or otherwise pressed in contact with at least a second substrate in contact with said slurry and residing opposite to said first substrate.

17. A method for producing a high permittivity dielectric material in a low or ambient temperature environment comprising:
a. creating a first solution consisting of an amount of silicone oil combined by stirring in a finely ground high permittivity dielectric;
b. while said first solution is being stirred, a small amount of sodium borohydride or borax salt is added to said first solution with continued stirring until said first solution is mixed into a slurry;
c. said slurry is then applied to a first substrate;
d. said first substrate with said slurry applied is heated to a first temperature range for a first period of time to facilitate the increase in viscosity of said silicone oil;
e. after said first period of time, a second substrate is applied to the top of said slurry and opposite to said first substrate;
f. said first substrate and said second substrate with said slurry residing between them are clamped or pressed together then heat treated at a second temperature range for a second period of time to stabilize the said dielectric material.

18. The methods of any one of claims 13, 14, 15, 16, 17 where said first solution is processed to remove any particulate matter not dissolved into said first solution by filtering said first solution or by centrifuging said first solution then drawing off a clear portion of said first solution without any of said particulate matter.

19. A method for producing a high permittivity dielectric material in a low or ambient temperature environment comprising:
a. creating a first solution consisting of an amount of organic acid and a mixture of inorganic base;
b. evaporating the resultant solution to create an organic acid inorganic base salt;
c. melting, casting, or otherwise forming the resultant organic inorganic salt base into a polymer matrix by admixing or simply forming the salt into a thin film while in an amorphous pliable and/or crystalline form.

20. A method for producing a high permittivity dielectric material for use in a capacitor utilizing any one of a plurality of organic acids such as cysteine, taurine, carballylic acid, citric acid, glutathione, citrulline, potassium dihydrogen phosphate, ethylenediaminetetraacetic acid, trithiocyanuric acid, cyanuric acid, tartaric acid, salicylic acid, arginine, cystine, succinic acid comprising:
a. creating a first solution consisting of an amount of organic acid and a mixture of inorganic or organic base;
b. evaporating the resultant solution to create an organic acid inorganic or organic base salt;
c. melting, casting, or otherwise forming the resultant organic or inorganic salt base into a polymer matrix by admixing or simply forming the salt and polymer mixture into a thin film while in an amorphous pliable and/or crystalline form.

21. A method for producing a high permittivity dielectric material for use in a capacitor utilizing sulfur containing molecules wherein the sulfur is contained within a molecule that has an acidic functionality:
a. creating a first solution consisting of a solvent or polymer carrier composed of said carrier and said dielectric material comprising;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

22. A method for producing a high permittivity dielectric material for use in a capacitor utilizing sulfur containing molecules wherein the sulfur is contained within a molecule that has a thio (mercaptan) functionality comprising:
a. creating a first solution consisting of a solvent or polymer carrier composed of said carrier and said dielectric material;
b. mixing of said solution until said solution is mixed into a slurry;
c. placement of said slurry onto said a substrate as an even coating;
d. placement of a second substrate onto said slurry opposite to said first substrate thereby forming a capacitor assembly;
e. Allowing said slurry to cure or dry for a first period of time.

23. A method for producing a high permittivity dielectric material for use in a capacitor utilizing a base to produce a salt where the base selected is a nitrogen containing one of a plurality of conjugated nitrogen bases, pyridines, anilines comprising:
a. creating a first solution consisting of a solvent or polymer carrier composed of said carrier and said nitrogen base;
b. mixing of said solution until said solution is mixed into a slurry;
c. placement of said slurry onto said a substrate as an even coating;
d. placement of a second substrate onto said slurry opposite to said first substrate thereby forming a capacitor assembly;
e. Allowing said slurry to cure or dry for a first period of time.

24. A method for producing a high permittivity dielectric material for use in a capacitor utilizing a nitrogen base and an organic acid where the permittivity is greater than 50 comprising:
a. creating a first solution consisting of a solvent or polymer carrier composed of said carrier and said dielectric material;
b. mixing of said solution until said solution is mixed into a slurry;
c. placement of said slurry onto said a substrate as an even coating;
d. placement of a second substrate onto said slurry opposite to said first substrate thereby forming a capacitor assembly;
e. Allowing said slurry to cure or dry for a first period of time.

25. A method for producing a high permittivity dielectric material for use in a capacitor utilizing one of a plurality of a sulfur containing adjuvants selected from the following Thioureas, Thiobiurets, Thiouracil, Mercaptans, or Thiophenol comprising:
a. creating a first solution consisting of a solvent or polymer carrier composed of said carrier and said sulfur containing adjuvant;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

26. A method for producing a high permittivity dielectric material for use in a capacitor utilizing a mixture of organic salts and sulfur containing compounds comprising:
a. creating a first solution consisting of a solvent or polymer carrier composed of said carrier and said dielectric material;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

27. A method for producing a high permittivity dielectric material for use in a capacitor utilizing rubidium and organic acids as their respective salts comprising:
a. creating a first solution consisting of a solvent or polymer carrier composed of said carrier and said dielectric material;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

28. A method for producing a high permittivity dielectric material for use in a capacitor utilizing cesium and organic acids as their respective salts comprising:
a. creating a first solution consisting of a solvent or polymer carrier composed of said carrier and said dielectric material;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

29. A method for producing a high permittivity dielectric material for use in a capacitor utilizing copper and organic acids as their respective salts comprising:
a. creating a first solution consisting of a solvent or polymer carrier composed of said carrier and said dielectric material;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

30. A method for producing a high permittivity dielectric material for use in a capacitor utilizing indium and organic acids as their respective salts comprising:
a. creating a first solution consisting of a solvent or polymer carrier composed of said carrier and said dielectric material;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

31. A method for producing a high permittivity dielectric material for use in a capacitor utilizing gallium and organic acids as their respective salts comprising:
a. creating a first solution consisting of a solvent or polymer carrier composed of said carrier and said dielectric material;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

32. A method for producing a high permittivity dielectric material for use in a capacitor utilizing silver and organic acids as their respective salts comprising:
a. creating a first solution consisting of a solvent or polymer carrier composed of said carrier and said dielectric material;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

33. A method for producing a high permittivity dielectric material for use in a capacitor wherein an organic acid salt dielectric is suspended in a polymer base comprising:
a. creating a first solution consisting of a solvent or polymer carrier composed of said carrier and said dielectric material;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

34. A method for producing a high permittivity dielectric material for use in a capacitor wherein an organic acid salt dielectric is suspended in a polymer base made from an acrylic, methacrylic, methacrylic amide, acrylic amide, or cyanoacrylate types of polymers comprising:
a. creating a first solution consisting of said polymer and said dielectric material;
b. mixing of said solution until said solution is mixed into a slurry;
c. placement of said slurry onto a first substrate as an even coating;
d. placement of a second substrate onto said slurry opposite to said first substrate thereby forming a capacitor assembly;
e. Allowing said slurry to cure or dry for a first period of time.

35. A method for producing a high permittivity dielectric material for use in a capacitor wherein a dielectric is suspended in a polymer base comprised of polyvinyl sulfonic acid salts or derivatives thereof comprising:
a. creating a first solution consisting of a polymer carrier and said dielectric material;
b. mixing of said solution until said solution is mixed into a slurry;
c. placement of said slurry onto said a first substrate as an even coating;
d. placement of a second substrate onto said slurry opposite to said first substrate thereby forming a capacitor assembly;
e. Allowing said slurry to cure or dry for a first period of time.
